(19) United States
(12) Patent Application Publication
(10) Pub. No.: US 2011/0011892 A1
(43) Pub. Date: Jan. 20, 2011

(54) Dispensing device

(76) Inventor: Lloyd Ewuzie Ezinwa Igbokwe, Herndon, VA (US)

Correspondence Address: Dr. Benjamin Adler;ADLER & ASSOCIATES, 8011 Candle Lane, Houston, TX, 77071, US

(21) Appl. No.: 12/460,142

(22) Filed: Jul. 14, 2009

(51) Int. Cl. B67D 5/64

(52) U.S. Cl. 222/173; 222/129

(57) ABSTRACT

A dispensing device that may hold at least two bottles in place. The device may be able to hold a system comprising multiple bottles and/or cans in place. The device may comprise a grip, means for supporting fluid containers, a chamber that facilitates equal distribution and efficient discharge of liquids via a spout.

### BACKGROUND OF THE INVENTION

1. Field of the Invention

The present invention relates, in general, to bottle holders and dispensers of liquids and solids materials. Particularly, this invention relates to a device that can dispense two or more liquids or solids by facilitating in-situ, even mixing of liquids or solids at the time of dispensation.

2. Description of the Related Art

Many types of dispensers have been used to distribute fluids and are well known in the prior art. For example, U.S. Pat. No. 6,109,482, issued to Briggs, discloses a soda dispensing assembly comprising a base having a recess formed therein for receiving a neck of an inverted bottle to receive fluid therefrom. A spigot is coupled to a bottom of the recess and a bottom end extending therefrom so as to exit the base and terminate in an open end, and a valve mechanism selectively allows fluid to flow from the open end of the spigot.

U.S. Pat. No. 4,715,516, issued to Salvail, discloses an apparatus that dispenses carbonated beverages from a container. A body portion is adapted to replace a screw top cap of the container. The body portion includes a tube which projects into the ullage volume of the container and vents to the atmosphere via a vent valve. A fluid valve is disposed in the body portion between a fluid chamber and a spout. In use, the container having the body portion attached thereto is essentially inverted and supported in a stand. A dispensing lever attached to the body is depressed and sequentially opens the vent valve and the fluid valve permitting the beverage to flow through the fluid chamber, the fluid valve and the spout by gravity.

U.S. Pat. No. 4,386,718, issued to Stewart et al, discloses a dispenser of liquid from an inverted rigid screw neck container, the dispenser including a base with an upwardly directed socket to receive the container neck in a liquid tight manner, a port to discharge liquid to a threaded nose to be coupled to a tap, an air bleed arrangement to deliver atmospheric air through a stem and a one way valve into a container when mounted on the base.

U.S. Pat. No. 3,042,267, issued to Reynard, discloses a dispensing device for a liquid including a support provided with an opening and a pair of passages disposed alongside one another and having open outer ends at one side of the device. A container for a liquid has an opening communicating with the opening in the support and one of the passages through which the liquid may be released. Means for connecting the other passage with the interior of the container for venting air through the passage, means mounted on the support, and a pair of resilient valve means connected to the mounted means at a location exteriorly of the passages for opening and closing the outer ends for respectively controlling the flow of liquid and air through such passages.

U.S. Pat. No. 6,540,111, issued to Lukasik, discloses a bottled soda dispenser for dispensing soda from a 2-liter bottle without having to remove the cap each time. The invention allows for one hand dispensing and keeps the carbonation in the bottle. The dispenser consists of the base, a bottle holder, a valve system and actuating levers. An air inlet having a check valve provides sufficient air in the bottle as the soda is withdrawn.

The art is deficient in a bottle holder that can hold two or more liquid containers upright, and facilitate an even mixing of the liquids at the time of dispensation without contaminating individual bottles or reservoirs. The instant invention overcomes this deficiency in the art.

### SUMMARY OF THE INVENTION

The present invention provides a bottle and/or can holder, which is also a dispensing device. The dispensing device of the present invention includes a stand-alone vertical frame widened at the base for stability.

The frame of the dispensing device of the present invention features two or more means for supporting containers that run on track systems embedded on the sides of the stand, and can be locked at desired heights, depending on the liquid or solid container.

The frame of the dispensing device of the present invention comprises a grip to facilitate easy transportation of the apparatus. Additionally, the frame also features a detachable handle with a grip for easy handling. The handle may be attached to the frame by means of pin connectors. The grips may be manufactured from rubber, industrial foam or plastic.

The frame of the dispensing device of the present invention may be fastened by means of a pin connector onto a chamber that features leak-proof inlets for the liquid-containers and also a spout for dispensing liquids after mixing. The chamber may be dome shaped, cylindrical, hexagonal or octagonal. The chamber may be made of any suitable material such as plastic, glass or light-weight aluminum. The spout of the chamber can be closed using a cap or by activating a locking mechanism.

One of the primary objects of the present invention is to provide a dispensing device to enable a user to dispense liquids or solids from bottles and/or cans without spilling.

Another object of the present invention is to provide a dispenser that will enable children to easily mix beverages and serve themselves.

Still another object of the present invention is to provide a dispensing device that will eliminate the need for a user to lift multiple bottles and/or cans one at a time in order to mix quantities of liquids from such bottles.

Yet another object of the present invention is to provide a dispensing device that can be used to form a single dispensing machine carrying multiple bottles and/or cans of the same liquid for the convenience of the user.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of the invention according to a first embodiment of the invention.

FIG. 2A and FIG. 2B are partial perspective views of the invention according to a first embodiment of the invention.

FIG. 3 is a partial perspective view of a part of the invention according to a first embodiment of the invention.

FIG. 4 is a partial perspective view of a part of the invention according to a first embodiment of the invention.

FIG. 5 is a partial perspective view of the invention according to a first embodiment of the invention.

### DETAILED DESCRIPTION OF THE INVENTION

As used herein the specification, “a” or “an” may mean one or more. As used herein in the claim(s), when used in conjunction with the word “comprising”, the words “a” or “an” may mean one or more than one. As used herein “another” or “other” may mean at least a second or more of the same or different claim element or components thereof. Furthermore, unless otherwise required by context, singular terms shall include pluralities and plural terms shall include the singular.

As used herein, the term “or” in the claims is used to mean “and/or” unless explicitly indicated to refer to alternatives only or the alternatives are mutually exclusive, although the disclosure supports a definition that refers to only alternatives and “and/or.”

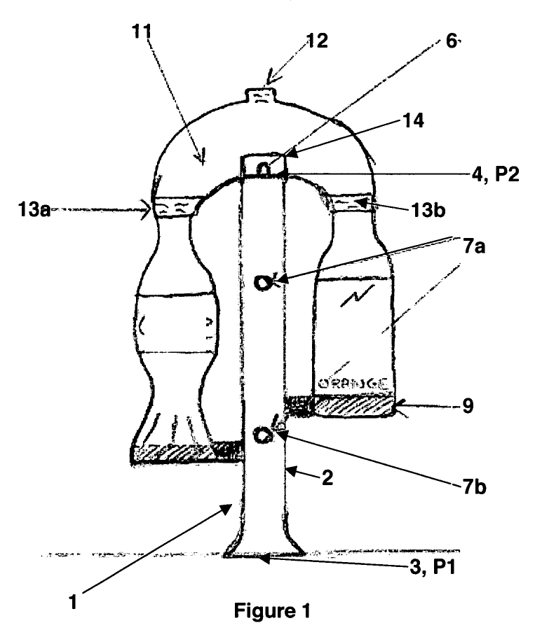

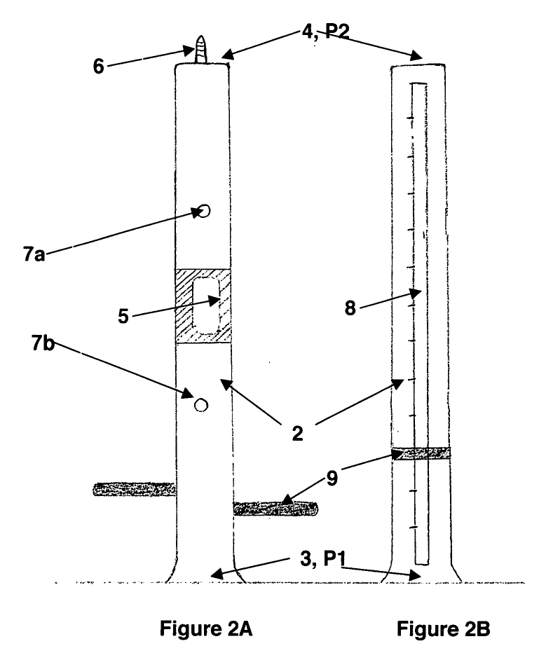

The present invention provides a dispensing device, generally designated 1, (FIG. 1). Such dispensing device 1 includes a stand-alone vertical frame 2 (FIGS. 2A, 2B). The vertical frame 2 comprises a lower surface, 3 and an upper surface 4. The lower surface 3 may have a perimeter P1 that is greater in magnitude than the perimeter P2 of the upper surface 4, in order to stabilize the apparatus.

In a presently preferred embodiment, the frame 2 is comprised of aluminum. Frame 2 may, however, also be comprised of suitable material know to those of ordinary skill in this art, including plastic, glass, steel, titanium or combinations thereof.

In a presently preferred embodiment, the frame 2 has a grip 5 to enable easy transportation of the apparatus. The frame 2 further features a pin connector 6 on top in order to fasten the chamber 11 to the upper surface 4 of the frame 2. The frame 2 also has handle clips 7a,b for fastening the handle 21. The frame 2 has multiple receptacles, 8 embedded on its sides. Means for supporting containers, 9 are locked at desired heights on suitable receptacle, 8 by means of locking means 91 (FIG. 5).

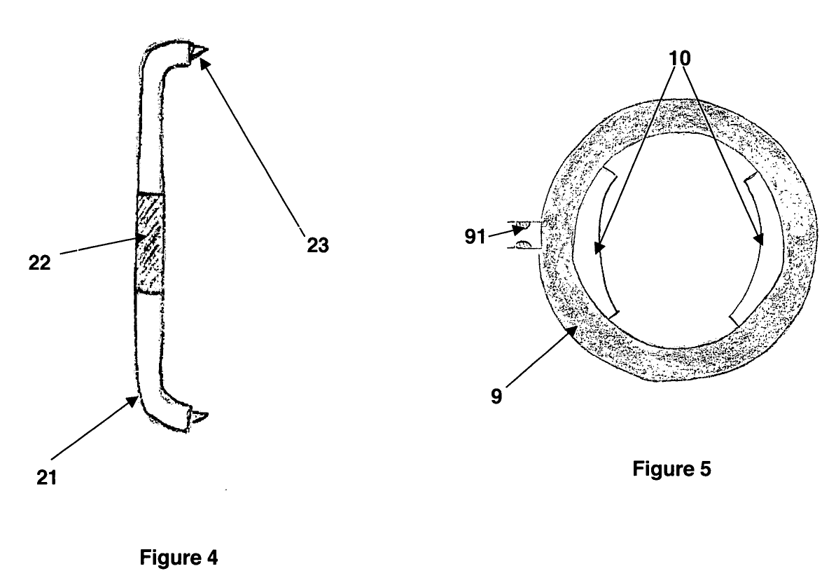

In the present embodiment, the handle 21 features a grip, 22, and pin connectors, 23, for fastening the handle to the handle clips 7a,b of the frame 2 (FIG. 1, FIG. 4). Once fastened to the frame 2, there is a 2-inch clearance between the grip 22 and the frame 2. In certain embodiments, the handle comprises a first and second end independently attached to the frame, and the handle further comprises indentations for receiving fingers.

In the present embodiment, the means for supporting containers 9 are at least 0.5 inches in thickness and manufactured from plastic or aluminum or other durable material. Additionally, the means for supporting the containers may also comprise mats with non-slip grip. In certain embodiments, the means for supporting the containers may also comprise a retractable means 10 of gripping the container (FIG. 5). In all embodiments, the supporting containers 9 comprise a locking means 91 in order to lock the supporting containers, 9 at desired heights on suitable receptacle 8.

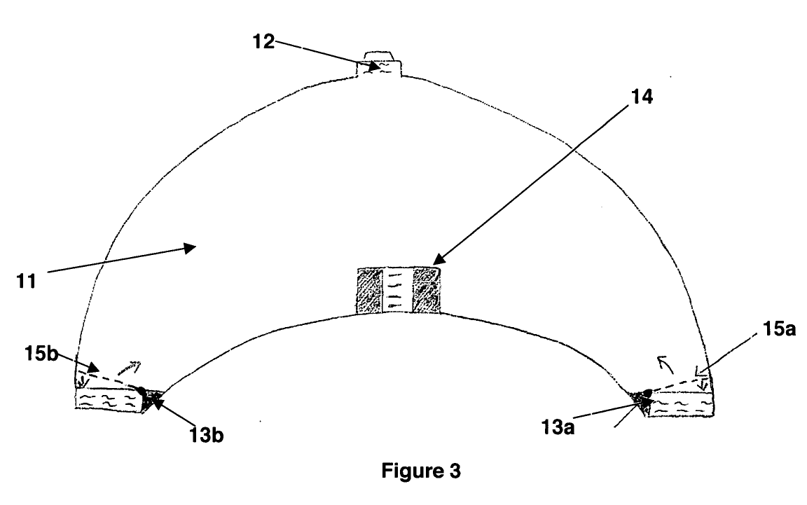

In a presently preferred embodiment, the chamber 11 is dome shaped and made of plastic (FIGS. 1, 3). In other embodiments, the chamber 11 may be made of glass or lightweight aluminum. In some of these embodiments, the chamber may be hexagonal or octagonal in shape. In a presently preferred embodiment, the chamber 11 comprises a spout 12 shaped like a traditional bottle opening for dispensing the fluid. In this embodiment, the spout is sealed by means of a screw-on lid. In other embodiments, the spout 12 may be shaped like the opening of a sport-bottle.

In a presently preferred embodiment, the chamber 11 further comprises inlets 13a,b that are pre-fabricated to fit the outlets of individual fluid containers (FIG. 3). The inlets 13a,b are designed to prevent liquid from leaking from the containers once such liquid-containers are inverted for dispensing of liquid or solid from within. In certain embodiments, the inlets 13a,b are threaded on the internal surface (FIG. 3). In some embodiments, the inlets 13a,b further comprise a means 15a,b of preventing contact of fluid from the chamber 11 with the liquid containers, said means remains closed in the upright (rest) position of the apparatus and opens when apparatus is tilted.

In the presently preferred embodiment, the chamber 11 is secured to pin connector 6 of the upper surface 4 of the frame 2 by means of the female fixed support 14 placed inside the chamber 11 such that frame 2 supports the chamber 11.

In certain embodiments, the chamber 11 further comprises a receptacle that frictionally embraces and retains the top end of the frame 2.

In certain embodiments of the instant invention there is provided a dispensing device comprising: a frame comprising an upper surface and a lower surface; a chamber attachable to the upper surface of said frame, the chamber comprising a spout and at least two inlets; and two or more means for supporting containers, the means attached to a receptacle on the frame.

In certain embodiments, the frame of the dispensing device of the present invention may be of any desirable size or shape, including but not limited to cylindrical, hexagonal, rectangular or octagonal. In these embodiments, the frame may be comprised of any suitable material, including but not limited to aluminum, plastic, titanium or steel.

In all embodiments of the instant invention, the frame has a lower surface that has a perimeter P1, that is greater in magnitude than the perimeter P2 of the upper surface of the frame.

In all embodiments, the frame comprises multiple receptacles for attachment of a means for the supporting container.

In certain embodiments of the instant invention, the means for supporting containers are platforms such as flat platforms and the platforms being circular, semi-circular, rectangular, square, hexagonal or octagonal. In other embodiments, the means for supporting containers are receptacles comprising an exterior wall, a closed bottom, and an open top. In certain embodiments, the means for supporting the containers also comprise mats with non-slip grip to ensure stability of the containers. In all embodiments, the means for supporting containers comprise a locking means for attachment to the receptacle on the frame.

In certain embodiments of the dispensing device of the present invention, the chamber is dome-shaped, cylindrical, hexagonal, rectangular or octagonal. In most of these embodiments, the chamber is comprised of aluminum, plastic, titanium, steel or combinations thereof. In certain embodiments, the chamber has an internal surface comprising inlets threaded thereon to which a fluid container is threadably attached. In certain other embodiments, the chamber frictionally embraces and retains the top of the fluid container. In certain embodiments, the chamber further comprises a spout and a built-in capping mechanism.

A preferred embodiment of the invention comprises a dispensing device comprising: a frame comprising an upper surface and a lower surface wherein the lower surface has a perimeter that is greater in magnitude than the perimeter of the upper surface; two or more means for supporting containers, the means attached to a receptacle on the frame; and a dome-shaped chamber attachable by means of pin connector to said upper surface of said frame, the chamber further comprising a spout and at least two inlets for containers, the inlets further comprising means of preventing contact of fluid from the chamber with the containers.

Another preferred embodiment of the dispensing device of the present invention consists of a dispensing device comprising: a frame comprising an upper surface and a lower surface wherein the lower surface has a perimeter that is greater in magnitude than the perimeter of the upper surface; two or more means for supporting containers which are attached to a receptacle on the frame, the means for supporting containers further comprising mats with non-stick grip; a chamber comprising a receptacle that frictionally embraces and retains the top end of the frame, the chamber further comprising one spout and at least two inlets that are threaded and further comprise means of preventing contact of fluid from chamber with the containers.

Unless otherwise specified in the embodiments, all connectors used are pins with corresponding female components embedded in the mixing chamber or the cylindrical frame as required.

In certain embodiments, the grips are manufactured from rubber, industrial foam or plastic. In other certain embodiments, the grips further comprise indentations for receiving fingers.

While presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed is:

1. A dispensing device comprising:
a frame comprising an upper surface and a lower surface;
a chamber that is attachable to said upper surface of said frame, said chamber further comprising a spout and at least two inlets for containers; and
two or more means for supporting containers, said means attached to a receptacle on said frame.

2. A dispensing device according to claim 1 wherein said frame is cylindrical, hexagonal, rectangular or octagonal.

3. A dispensing device according to claim 1, wherein said frame is composed of aluminum, plastic, titanium or steel.

4. A dispensing device according to claim 1, wherein said lower surface has a perimeter that is greater in magnitude than the perimeter of said upper surface.

5. A dispensing device according to claim 1, wherein said frame comprises multiple receptacles for attachment of said means for supporting container.

6. A dispensing device according to claim 1, wherein said frame further comprises a grip.

7. A dispensing device according to claim 6, wherein said grip is manufactured from rubber, industrial foam or plastic.

8. A dispensing device according to claim 1, wherein said means for supporting container is a flat platform or a receptacle comprising an exterior wall, a closed bottom, and an open top; and
wherein said means for supporting container comprises a locking means for attachment to said receptacle on said frame.

9. A dispensing device according to claim 9, wherein said means for supporting container further comprises a retractable means of gripping the container.

10. A dispensing device according to claim 1, wherein said means for supporting containers are comprised of aluminum, plastic, titanium, steel or combinations thereof.

11. A dispensing device according to claim 1, wherein said means for supporting containers further comprise mats with non-slip grip.

12. A dispensing device according to claim 1, wherein said chamber is comprised of aluminum, plastic or steel.

13. A dispensing device according to claim 1, wherein said inlets are threaded on the internal surface, and wherein said inlets for containers further comprise means of preventing contact of fluid from said chamber with said containers.

14. A dispensing device according to claim 1, wherein said spout further comprises a retractable built-in capping mechanism, screw top or is a plain spout.

15. A dispensing device according to claim 1, wherein said chamber is attached to the upper surface of said frame by means of a pin connector.

16. A dispensing device according to claim 1 wherein said chamber further comprises a receptacle that frictionally embraces and retains the top end of the frame.

17. A dispensing device according to claim 1 further comprising a handle attached to the frame by means of at least one pin connector.

18. A dispensing device according to claim 16 wherein said handle comprises a first and second end independently attached to the frame, and wherein said handle further comprises indentations for receiving fingers.

19. A dispensing device comprising:
a frame comprising an upper surface and a lower surface wherein said lower surface has a perimeter that is greater in magnitude than the perimeter of said upper surface;
two or more means for supporting containers, said means comprising a locking means for attachment to a receptacle on said frame; and
a dome-shaped chamber attachable by means of pin connector to said upper surface of said frame, said chamber further comprising a spout and at least two inlets for containers, said inlets further comprising means of preventing contact of fluid from said chamber with said containers.

20. A dispensing device comprising:
a frame comprising an upper surface and a lower surface wherein said lower surface has a perimeter that is greater in magnitude than the perimeter of said upper surface;
two or more means for supporting containers, said means comprising a locking means for attachment to a receptacle on said frame, and said means further comprising mats with non-stick grip;
a chamber comprising a receptacle that frictionally embraces and retains the top end of the frame, said chamber further comprising one spout and at least two inlets, wherein said inlets are threaded and further comprise means of preventing contact of fluid from said chamber with said containers.
